(19) United States
(12) Patent Application Publication
(10) Pub. No.: US 2007/0162591 A1
(43) Pub. Date: Jul. 12, 2007

(54) NETWORK EQUIPMENT RESTART INDICATION

(75) Inventors: Frederick Y. Mo, Short Hills, NJ (US); Yang Wang, Princeton, NJ (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTSTARCOM, INC., Alameda, CA (US)

(21) Appl. No.: 11/306,733

(22) Filed: Jan. 9, 2006

(51) Int. Cl. G06F 15/173

(52) U.S. Cl. 709/224

(57) ABSTRACT

A network element (140) uses a non-volatile memory (150) to store indicia of reboots. The indicia of reboots are communicated over a network to a network manager (110). The network manager (110) compares the indicia of reboots and a prior indicia of reboots to assess whether a network element (140) has rebooted. The network elements preferably store a count of reboots as the indicia.

### BACKGROUND OF THE INVENTIONS

1. Technical Field

The present inventions relate to network equipment and, more particularly, relate to equipment indications on a network.

2. Description of the Related Art

In a network it is necessary for equipment to monitor the status of other equipment. When some equipment shuts down and reboots, other equipment needs to monitor its status.

A problem is that often the equipment doing the monitoring shuts down as well. For example, upon a power failure or network failure, most or all of the equipment will shutdown. When monitoring equipment is unable to check the other equipment, there is no knowledge of how much or how often the other equipment had trouble or restarted.

Prior solutions require a system to have a real-time clock. Otherwise it cannot correctly identify if equipment has been reset.

What is needed is a more knowledgeable and more intelligent way of determining the status of monitored network equipment.

A method is needed to correctly identify a reset 100% of the time.

### SUMMARY OF THE INVENTIONS

An object of the present inventions is to enable a network manager to correctly identify if equipment has been reset.

Another object of the present inventions is to enable a network manager to perform the optimum information synchronization selection.

Also an additional object of the present inventions is to provide information such as how many times equipment has been restarted even if the network manager was not running for a while.

An additional other object of the present inventions is to provide information such as how many times equipment has been restarted even if a node does not have a real-time clock or hard disk which many low cost systems do not have.

Another further object of the present inventions is to provide a better feeling about the quality of products and reliance on system information displayed by a network manager.

An additional object of the present inventions is to help identify real problems in a network by providing accurate alarm information and result in better system reliability or shorter downtime.

A network element uses a non-volatile memory to store indicia of reboots. The indicia of reboots are communicated over a network to a network manager. The network manager compares the indicia of reboots and a prior indicia of reboots to assess whether a network element has rebooted. The network elements preferably store a count of reboots as the indicia.

The details of the preferred embodiments and these and other objects and features of the inventions will be more readily understood from the following detailed description when read in conjunction with the accompanying drawings wherein:

### BRIEF DESCRIPTION OF THE DRAWINGS

FIG. 1 illustrates a schematic block diagram of network equipment according to the present inventions;

FIG. 2 illustrates a flow diagram of an exemplary monitored network element of the present inventions; and

FIG. 3 illustrates a flow diagram of a monitoring network manager of the present inventions.

### DETAILED DESCRIPTION OF THE PREFERRED EMBODIMENTS

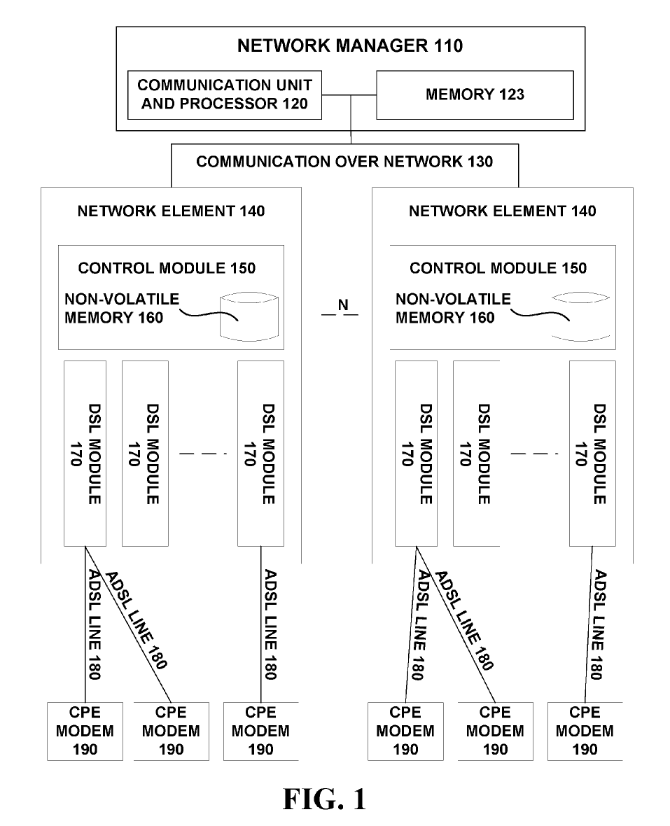

FIG. 1 illustrates a schematic block diagram of network equipment. A network manager 110 communicates with a plurality of ‘N’ network elements 140 over a network 130 such as over an ethernet or RS-232 connection. The network manager 110 is preferably a server or other computing device having a communication unit and processor 120 and memory 123. The memory 123 can be both random access memory and a hard drive in the server. The communication unit couples the network manager 110 and the network 130 for communication of binary value messages.

The network manager 110 monitors the network elements 140 to determine their status as such as, preferably the reboot status of the elements 140. A reboot is a restart of the network element or a portion of the network element.

Each network element 140 contains a control module 150 and a plurality of DSL (digital subscriber line) modules 170. The DSL modules 170 connect to customer premises equipment (CPE) modems 190 over an ADSL (asynchronous DSL) lines 180. The network elements with their DSL modems make up a DSLAM (digital subscriber line access multiplexer). The DSL modules 170 are line modules that can contain the DSL modem itself or can connect to other hardware containing the DSL modem. Each DSL module can support 24 to 48 customer premises equipment (CPE) modems 190 in one commercial example.

The network element 140 contains a non-volatile memory 160. The non-volatile memory 160 is preferably a flash memory or alternatively a hard drive. The non-volatile memory 160 stores a session ID of the network element. Preferably, this session ID is a counter value representing a number of reboots of the network element 140. Alternatively, however, the non-volatile memory 160 can store other forms of session ID such as a timestamp. In a preferred embodiment, the non-volatile memory 160 increments its count every time the control module 150 reboots. The session ID can be a single byte or up to 32 bit word.

The network manager 110 monitors the session ID in the non-volatile memory 160 reads the session IDs and thus knows the status of the network elements 140. When the non-volatile memory contains a count of reboots, the network manager compares the count read from the non-volatile memory of a given network element 140 against a previous count for that given network element stored in the network manager's memory 123. The difference tells the network manager 110 that the given network element 140 had rebooted since the last check.

In a situation where there is a power failure or other network manager downtime, the network manager is unable to continuously monitor the network elements. Having available a session ID, such as a reboot or timestamp, the network manager 110 is always able to determine that trouble previously existed in the different network elements.

The network manager memory 123 stores a previous count corresponding to a given network element. A comparator in a processor 120 of the network manager compares the indicia of reboots read from a network element 140 and the previous count in the memory 123 to assess whether the network element 140 has rebooted. The comparator can comprise a subtractor for determining a difference between the indicia of reboots read from the network element and the previous count in the memory to determine a number of times the network element has rebooted.

Alternatively, when the network element stores a session ID of a time stamp instead of a count, the processor 120 of the network manager compares a time stamp of a current network element session ID stored in the memory 123 and a time stamp of a network element session ID received in the indicia of reboots from a network element 140.

Although the non-volatile memory 160 is preferably contained within the control module 150 because it counts control module reboots, the non-volatile memory can be located anywhere within the network element whether or not it is counting reboots of the control module. This is also the case when logging reboot timestamps.

When the network manager 110 can determine where a reboot has occurred, the network manager 110 can perform diagnostics on the affected network element 140. For example, after a reboot is detected, the network manager 110 can synchronize information between network manager 110 and network element 140. Further, after a reboot is detected, the network manager 110 can download any necessary files such as configuration data file or upload new firmware to the network element 140. After a reboot is detected, the network manager 110 can also re-sync with the network element or re-load the same firmware in the network element 140. Also, after a reboot is detected, the network manager 110 can also log the reboot event that happened and update its internal copy of the session ID.

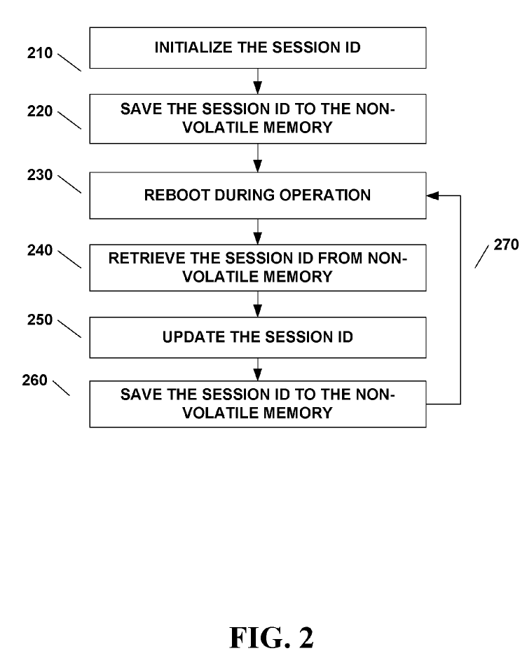

FIG. 2 illustrates a flow diagram of an exemplary monitored network element. The network equipment initializes its session ID at step 210. An initial session ID could be a timestamp or incrementing of a reboot counter for the network element. The session ID is then saved to the non-vile memory in step 220. A reboot may occur during operation of the network element at step 230. Upon a reboot, the session ID is retrieved from the non-volatile memory at step 240 and updated at step 250. This updated session ID is then saved to the non-volatile memory at step 260. Operation then continues at step 230 until the next reboot.

At any time during the operation of the steps of FIG. 2, the network element is able to return its session ID to the network manager upon request by the network manager.

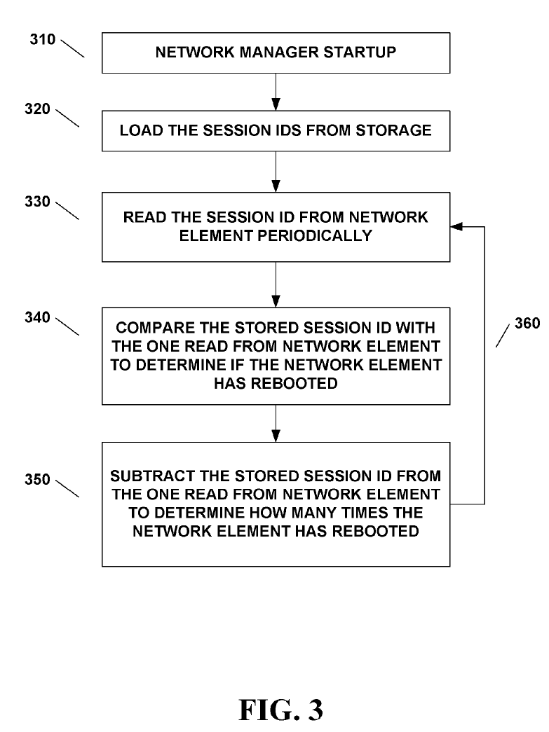

FIG. 3 illustrates a flow diagram of a monitoring network manager. The network manager starts up at step 310. The session IDs of all of the plurality of network elements are loaded from the storage memory of the network manager at step 310. The session ID is continually read from each of the plurality of network elements at step 330. While the session ID is preferably read on a periodic basis, the session ID can also be read on an intermittent or other error driven interrupt basis. At step 340, the stored session ID is compared with the session ID read from a given network element to determine if the given work element has rebooted. The previously stored session ID is subtracted from the one read from the given network element to determine how many times the given network element has rebooted at step 350. Operation then returns to the operation at step 330. At the operation in step 330, the session ID is again continually read from the network element.

Although a counter unit is illustrated in the exemplary flow diagram of FIG. 3, the session ID indicia of reboot of the network element could be the value of a timestamp or other value.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although DSL examples are disclosed, the inventions are applicable to other communications equipment such as voice access equipment and wireless network equipment and basestations and routers and telephone switches and CATV systems and set top-boxes.

What is claimed is:

1. A network element comprising:
a plurality of line modules;
a control module operatively coupled to the line modules for control;
a non-volatile memory to store indicia of reboots; and
a communication unit for communicating the indicia over a network.

2. A network element according to claim 1, wherein the non-volatile memory comprises a flash memory.

3. A network element according to claim 1, wherein the non-volatile memory comprises a hard drive.

4. A network element according to claim 1, wherein the non-volatile memory is comprised within the control module.

5. A network element according to claim 1, wherein the communication unit communicates a binary value message over a network connection.

6. A network element according to claim 1, wherein the non-volatile memory comprises a counter for counting reboots to provide the indicia of reboots.

7. A network element according to claim 6, wherein the counter counts reboots of the control module.

8. A network element according to claim 7, wherein the counter is comprised within the control module.

9. A network element according to claim 1, wherein the communication unit communicates the indicia over the network to a network manager.

10. A network element according to claim 1, further comprising a clock for providing a time and a memory for storing one or more time stamps corresponding to reboots.

11. A network element according to claim 1, wherein the network elements are in a rack.

12. A network element according to claim 1, wherein each line module corresponds to one or more line ports.

13. A network element according to claim 12, wherein each line port is associated with a DSLAM modem.

14. A network manager comprising:
a communication unit and a processor for communicating with and managing a network of network elements and for reading indicia of reboots from the network elements;
a memory for storing a prior indicia of reboots corresponding to a given network element; and
a comparator for comparing the indicia of reboots read from the network element and the prior indicia of reboots in the memory to assess whether the network element has rebooted.

15. A network manager according to claim 14, wherein the memory stores a previous count corresponding to a given network element and the comparator compares the indicia of reboots read from the network element and the previous count in the memory to assess whether the network element has rebooted.

16. A network manager according to claim 15, wherein the memory stores a previous count corresponding to a given network element and wherein the comparator comprises a subtractor for determining a difference between the indicia of reboots read from the network element and the previous count in the memory to determine a number of times the network element has rebooted.

17. A network manager according to claim 14, wherein the comparator compares a time stamp of a current network element session ID stored in the network manager and a time stamp of a network element session ID received in the indicia of reboots.

18. A network manager according to claim 14, wherein each network element corresponds to one or more line ports.

19. A network manager according to claim 18, wherein each line port is associated with a DSLAM modem managed by the network manager.

20. A network manager according to claim 14, wherein the communication unit and the processor are comprised in a server.
